(19) United States
(12) Patent Application Publication
(10) Pub. No.: US 2001/0000384 A1
(43) Pub. Date: Apr. 26, 2001

(54) Device for protecting securities

(75) Inventors: Guy Appeltans, Houthalen (BE); Luc Mellebeek, Opglabbeek (BE)

Correspondence Address: BACON & THOMAS, PLLC, 4th Floor, 625 Slaters Lane, Alexandria, VA, 22314-1176, US

(73) Assignee: FN HERSTAL, S.A.

(21) Appl. No.: 09/739,203

(22) Filed: Dec. 19, 2000

Related U.S. Application Data
(62) Division of application No. 09/147,728, filed on Feb. 25, 1999, now Pat. No. 6,178,897.
Application No. 09/147,728 is a 371 of international application No. PCT/BE97/00095, filed on Aug. 26, 1997.

(30) Foreign Application Priority Data
Sep. 2, 1996 (BE) 9600737

(51) Int. Cl. E05G 1/14; E05G 1/06; C06B 33/02; E05G 1/00

(52) U.S. Cl. 109/36; 109/; 109/53; 149/44

(57) ABSTRACT

The invention concerns a protective device for valuable documents, including a volume capable of being closed and divided into two compartments, one of the compartments being used to receive the documents to be protected while in the second compartment caps contain a pyrotechnic mixture which, when the device is wrongly manipulated, will burst into a flame and penetrate the documents in the first mentioned compartment.

1. The present invention concerns a device for protecting securities such as shares, bonds, bank notes and the like.

2. In particular, the present invention concerns a device of the type which is mounted in a fixed or portable manner in a private or public building, in a bank, in a means of transport or the like.

3. Devices of this type are already known which, when they are used in the wrong manner, for example in case of a burglary, or when the latter or similar devices are opened in an unwanted manner, the content is exposed to ink, smoke or another material so as to damage or destroy the securities.

4. However, it was found that when the papers provided in these known devices so as to protect them are not always entirely damaged and/or destroyed after somebody has attempted to open the device in an unwanted manner or after somebody has entered the wrong code in case of combination locks or such.

5. It was found that in those cases, a relatively large number of securities remains nevertheless undamaged, such that it is still worth while to force such device.

6. The present invention aims a device for protecting securities, in particular a device which makes these papers completely useless when the device is opened in an unwanted manner or when the device is manipulated by someone who does not know the code, but in such a manner that data provided on these papers, such as identification numbers or such remain intact.

7. To this aim, the present invention concerns a device consisting of a unit which can be closed, and which is divided in at least two spaces, whereby the first space is designed to hold the documents to be protected, whereas capsules comprising a pyrotechnical mixture are provided in the second space which capsules, when the device is manipulated in an unwanted manner, will inflame so as to produce a flame which transpierces so to speak the documents contained in the first space.

8. According to a preferred embodiment, the device according to the present invention will be equipped with at least one maze or labyrinth through which the produced gases can escape, such that flames nor gases under pressure can in no way whatsoever escape from the device when the security system is activated.

9. In a similar manner, retardation mechanisms can be provided on the means causing the destruction of the securities, such that the latter are destroyed at short intervals, so as to avoid that the destruction is too brutal at a given moment and that flames and/or gases under pressure escape from the device.

10. In order to better explain the characteristics of the invention, the following two devices according to the invention are described as an example only without being limitative in any way, with reference to the accompanying drawings, in which:

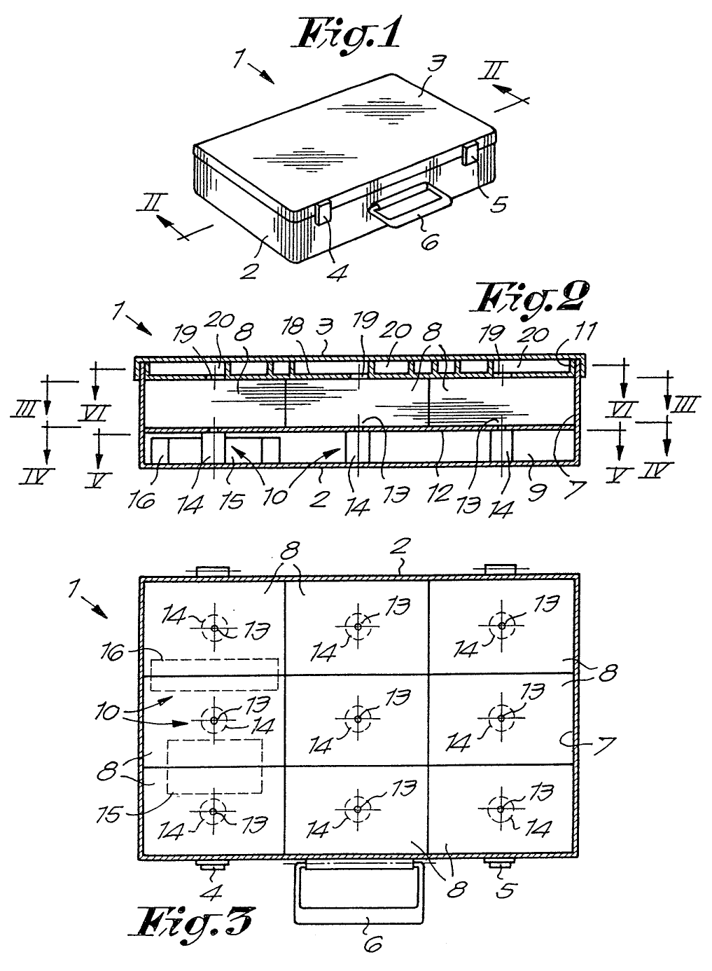

11. FIG. 1 shows a view in perspective of a device according to the invention, made in this case in the shape of a portable briefcase;

12. FIG. 2 shows a section according to line II—II in FIG. 1 to a larger scale;

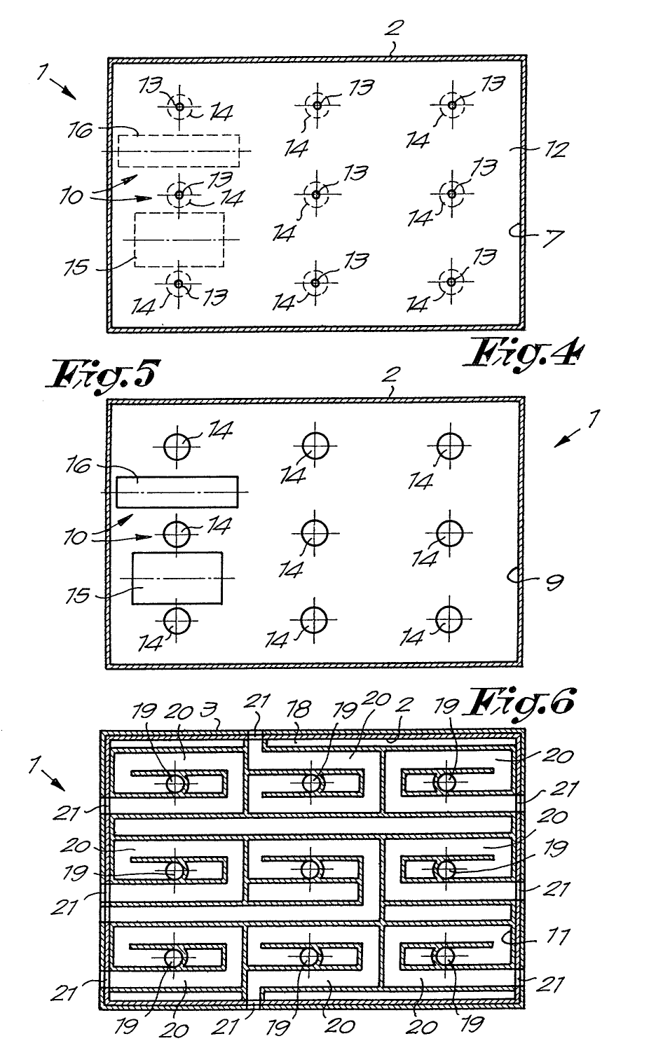

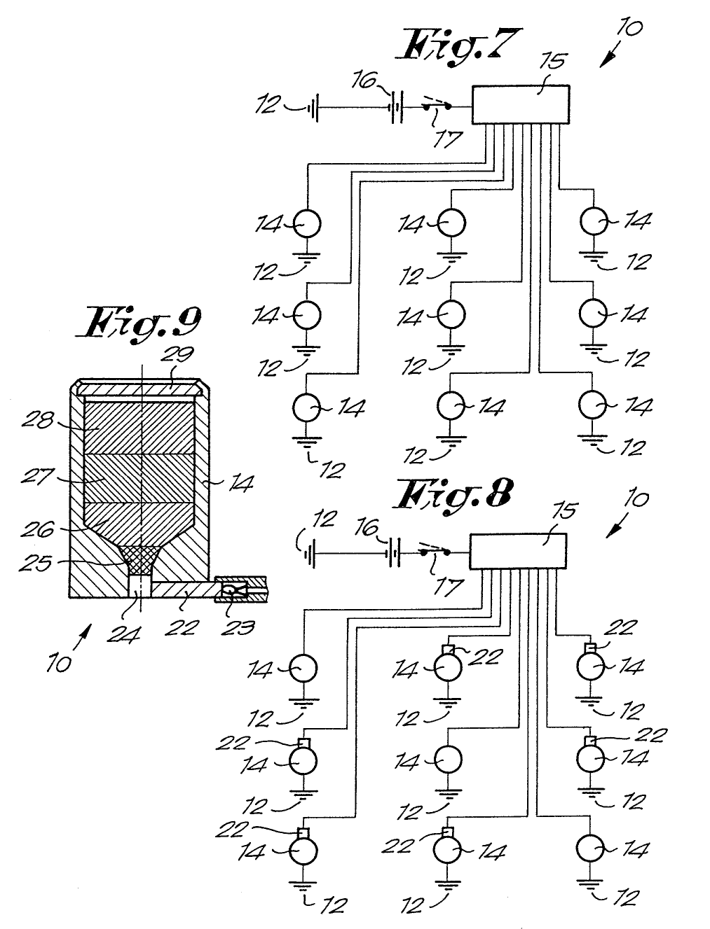

13. FIGS. 3, 4, 5 and 6 respectively show sections according to lines III—III, IV—IV, V—V and VI—VI in FIG. 2;

14. FIG. 7 shows a connection diagram of the ignition device according to the invention;

15. FIG. 8 shows a connection diagram of the same type as in FIG. 7, but for another embodiment;

16. FIG. 9 shows a cross section of an ignition capsule as used in the device according to the invention;

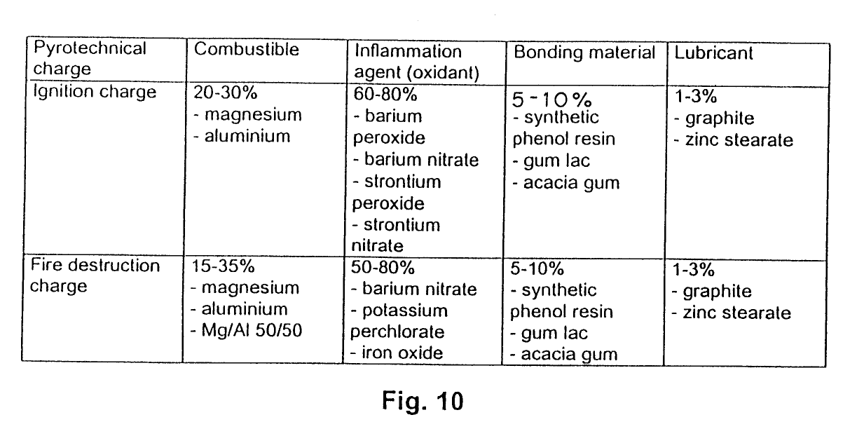

17. FIG. 10 represents a table of possible pyrotechnical mixtures;

18. FIG. 11 shows a front view of a device according to the invention, but in relation to another embodiment, namely in the shape of a safety box;

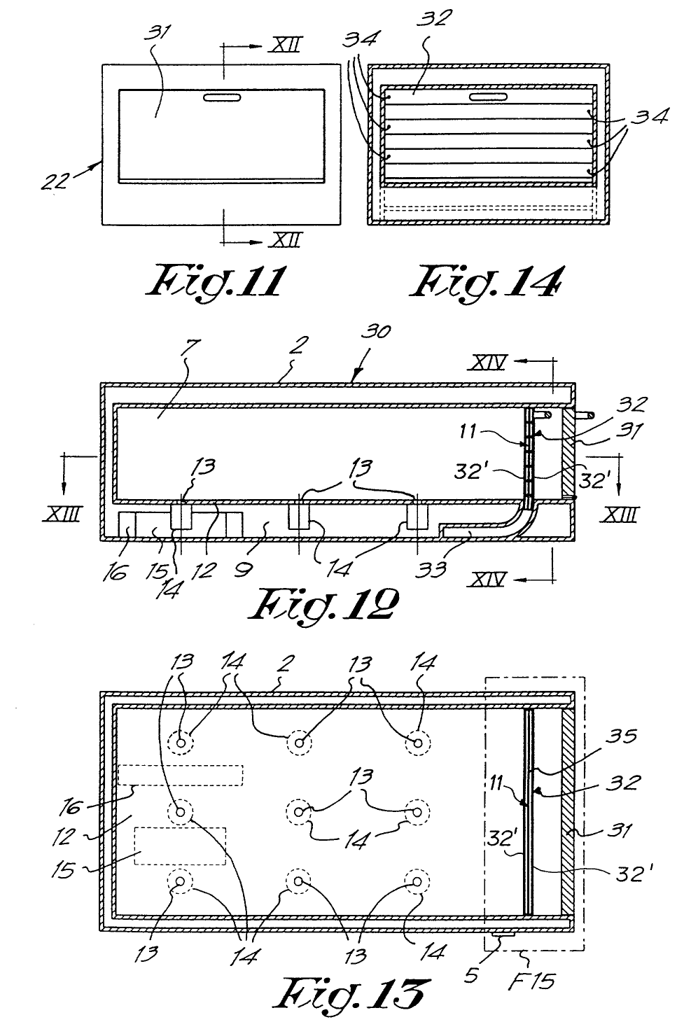

19. FIG. 12 shows a section according to lines XII—XII in FIG. 11;

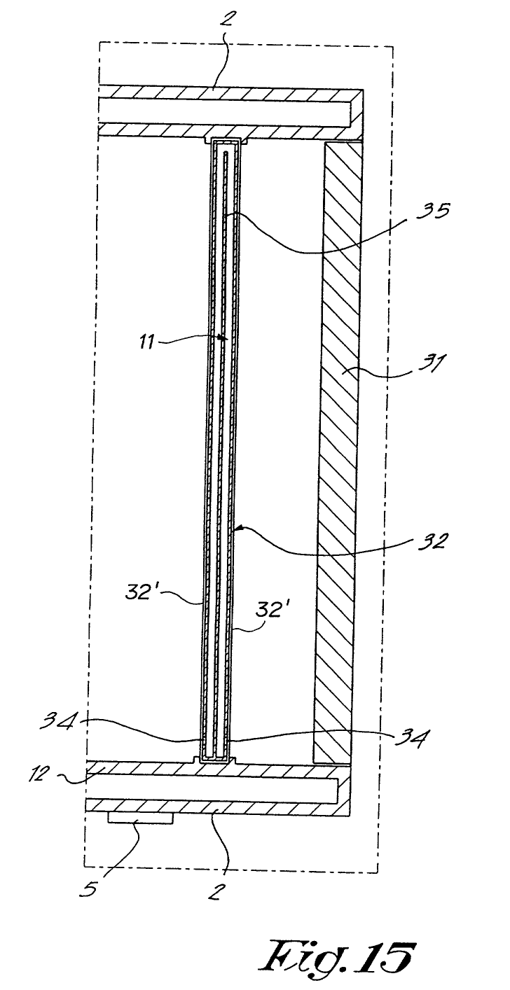

20. FIGS. 13 and 14 show sections according to lines XIII—XIII and XIV—XIV in FIG. 12;

21. FIG. 15 shows the part indicated by F15 in FIG. 13 to a larger scale.

22. Although by a device is understood a portable briefcase or safety box in the examples described hereafter, it is clear that the present invention may also apply to fixed as well as moveable devices such as for example a safe or such.

23. A portable briefcase 1 is represented in FIGS. 1 to 6 which mainly consists of a base 2 and a lid 3 which is connected to the base 2 by means of appropriate hinges and locks 4-5 which are not represented here, and whose base is equipped with a handle 6.

24. This portable briefcase 1 can be made in any material whatsoever.

25. In general, the volume of the portable briefcase 1 is subdivided in three separate spaces, namely a space 7 in which the securities 8, for example banknotes, can be safeguarded, a space 9 in which the ignition and fire destruction mechanism 10 is mounted and a space 11 in which one or several labyrinths are provided through which the flames or gases which are released during the ignition or destruction by the fire, provoked by the ignition and fire destruction mechanism 10, are diminished before leaving the device.

26. The above-mentioned spaces 7 and 9 are separated from one another by means of a metal plate 12, for example made of aluminium, in which a small hole 13 is provided on the spot where a wad of securities 8, for example banknotes, will be placed, whereby a capsule 14 is provided in the space 9 opposite each small hole 13, each filled with a pyrotechnical mixture.

27. All the capsules 14 are electrically connected to an electronic security system which, as represented in FIG. 7, can be built as follows:

28. Each capsule 14 is electrically connected to the ground consisting in this case of the plate 12, and it is further connected to an electronic switching mechanism 15 which is placed in the electric circuit of a battery 16 situated between the switching mechanism 15 and the plate 12, whereby a reversing switch 17 is provided in the above-mentioned electric circuit which makes it possible to put the security device under tension.

29. The space 11 of the portable briefcase 1 is in this case confined by a plate 18 forming a division between said space 11 and the space 7, and which is made of metal, for example aluminium, whereby, relatively large holes 19 are provided in said plate 18, opposite each wad of papers 8, in particular coaxially in relation to the holes 13 provided in the plate 12.

30. Moreover, the space 11 is subdivided in one or several mazes or labyrinths, in this case one labyrinth 20 per capsule 14, whereby these labyrinths 20 open into the atmosphere via a passage 21 provided to this end in the external wall of the space 11 and in the adjacent walls of the base 2 and the lid 3.

31. FIG. 8 shows a variant of the diagram according to FIG. 7, whereby, in this case, certain capsules 14 are equipped with what is called a retardation device 22 which forms a barrier between the ignition mechanism 23 and the pyrotechnical mixture of the capsule 14 so as to obtain a retarded ignition of the pyrotechnical mixture. These retardation devices may be identical to one another or they may be divided in groups or they may also be all different so as to obtain discharges going off at different moments.

32. Naturally, also other embodiments of the electronic security system are possible.

33. Thus, FIG. 9 represents a capsule 14 made of steel, whereby this capsule 14 is coupled to the retarding mechanism 22 via an opening 24, to the ignition mechanism 23 respectively, and whereby a pyrotechnical mixture is put in said capsule 14 consisting of what are called pyrotechnical charges, in this case an ignition charge 25 and three fire destruction charges 26, 27 and 28 which may have an appropriate composition, the whole being sealed by a small plate 29 made of nonflammable material. The pyrotechnical mixture may have any composition whatsoever; as an example only, a table of materials which can be used in any combination whatsoever, in compliance with the indicated proportions, in order to form an ignition charge 25, a fire destruction charge 26-27-28 respectively, is represented in FIG. 10.

34. The ignition charge may consist of magnesium, strontium peroxides and bonding materials, whereas the pyrotechnical mixture may consist of iron oxides, magnesium, aluminium, barium nitrate, graphite and synthetic phenol resin.

35. The use and working of the device according to the invention is very simple and as described below.

36. When a certain number of securities 8, for example bank notes, are put in a portable briefcase 1 according to the invention, for example in order to transport papers of this sort, these papers are placed exactly over the holes 13 provided in the plate 12, in the space 7 whose dimensions preferably correspond to those of the papers.

37. Then, the device 1 is closed such that the papers 8 are perfectly protected, whereby the reversing switch 17 is switched off in an appropriate manner as the briefcase is closed.

38. The reversing switch 17 can be provided at any place whatsoever, for example between the base 2 and the lid 3, in either of the locks 4-5, combined with a combination lock or combined with a keyboard for entering a code or via which one has to enter a code at regular intervals so as to switch off the reversing switch 17.

39. The reversing switch 17 or the electronic security system may also be remotely controlled, in which case the tripping of the security system does not need to coincide with the portable briefcase 1 being closed.

40. When someone wants to break into a portable briefcase 1 of this type, either by twisting the lid 3 or by distorting the locks 4 or 5, or also, in the case of a keyboard, by damaging this keyboard or by entering the wrong code, the reversing switch 17 will be switched on in the appropriate manner and, via the electronic switching mechanism 15, it will send a message to the capsules 14 ordering the ignition mechanism 23 to provoke the ignition of the ignition charge 25, and consequently of the fire destruction charges 26-27-28, such that, through the holes 13 provided in the plate 12, a flame is lit transpiercing the wads of papers 8, whereby this flame and the produced gases are then led through a labyrinth 20, where they are diminished before leaving the portable briefcase 1, such that flames and/or gases under pressure can by no means escape from the portable briefcase 1.

41. The thus realised piercing of the papers 8 may cause a conical, flattened burn hole in the wad of papers 8, having a diameter of about 3 to 4 cm in the base and of about 1 cm at the top, with a total height of at least 5 cm.

42. In this way, the papers 8 are made useless, but they remain as such, such that they can still be examined in one way or the other.

43. FIG. 8 shows another connection diagram in which is applied a retarding device 22 on certain capsules 14 so as to program the discharge of the capsules 14 such that, for example in the example represented in FIG. 8, three capsules 14 will flare up together, igniting a second series of three capsules 14 a few seconds later and finally igniting a third series of capsules 14 after another few seconds, such that the force of the ignition is spread in time.

44. FIGS. 11 to 15 represent another embodiment of the invention in which the device is made in the shape of a security box 30.

45. The construction is analogous to that of the portable briefcase 1, but the lid 3 is replaced by a flap 31 in a narrow side wall of the security box 30, whereas the space 11, in which are provided one or several labyrinths 20, is made in the shape of a revolving shutter 32.

46. FIGS. 11 to 15 represent identical or analogous elements or spaces having the same reference numbers as used in FIGS. 1 to 6.

47. In this embodiment, the plate 12 forms a tray, such that the space 9 in which is mounted the ignition and fire destruction mechanism 10 extends all around the space 7, with the exception of the front side where the flap 31 is provided.

48. The flap 31 can be bolted by means of a lock 5 with an electronic key.

49. The space 11 which forms one or several labyrinths 20 is not provided directly against the flap 31, but it is provided against the inside at a certain distance of the latter in the revolving shutter 32 which can glide over guides 33 in the space 9.

50. The slats of the revolving shutter 32 are double-walled and are made of metal, and they each have an opening 34 near one end. Said slat is divided in two in its longitudinal direction by means of a partition 35 which is connected at one end to the far end of the slat alongside which the openings 34 are provided, whereby the other end remains at a short distance from the other far end of the slat.

51. Thus, a labyrinth 20 is formed in each slat through which the ignition gases coming in via the opening 34 must cover a long distance before they come out of the opening 34 against the outer side of the slat in the space provided between the revolving shutter 32 and the flap 31. From this space they can escape into the atmosphere through the clearance of the flap 31.

52. Successive slats of the revolving shutter 32 are provided such that the openings 34 are provided alternately on either side of the revolving shutter 32.

53. By closing the flap 31 or after it has been closed via a remote control, the reversing switch 17 is switched off or the security system is activated in one way or another.

54. In case of violation, the security box 31 works in the same manner as described above for the portable briefcase 1 .

55. Thanks to the design of the revolving shutter 32 described above, neither flames nor gases under pressure can escape from this security box 30.

56. It is clear that the present invention is in noway limited to the embodiments described as example and shown in the annexed drawings; a device according to the invention may be realised in all sorts of shapes and dimensions without falling outside the scope of the invention.

What is claimed is:

1. Device for protecting securities characterized in that it consists of a unit which can be closed, and which is divided in at least two spaces (7 and 9), whereby the space (7) is designed to hold the documents (8) to be protected, whereas capsules (14) which comprise pyrotechnical mixture are provided in the second space (9) which, when the device is manipulated in an unwanted manner, will inflame so as to produce a flame which transpierces so to speak the documents (8) contained in the first space (7).

2. Device according to claim 1, characterized in that the spaces (7) and (9) are separated from one another by means of a metal plate (12) in which a small hole (13) is provided on the spot where each wad of papers (8) is placed, whereby an above-mentioned capsule (14) is provided in the space (9) opposite each small hole (13).

3. Device according to claim 2, characterized in that the metal plate (12) forms a tray in which is situated the space (7) to hold the documents (8) to be protected and which is provided with an opening in a side wall and which can be closed by means of a flap (31), whereby the flap (31) is also mounted on a base (2) surrounding the above-mentioned tray, and whereby the space (9) in which the capsules (14) are provided is situated between said tray and the base (2).

4. Device according to any of claims 1 to 3, characterized in that it has, apart from the two above-mentioned spaces (7) and (9), a third space (11) in which is provided at least one labyrinth (20) which is connected to the side reserved for a wad of papers (8) situated opposite the side which is directed towards a capsule (14) on the one hand, and which is connected to the atmosphere on the other hand.

5. Device according to claim 4, characterized in that the space (11) is separated from the space (7) by means of a metal plate (18) in which is provided a hole (19) on the spot where each wad of papers (8) is situated.

6. Device according to claims 2 and 5, characterized in that the holes (19) provided in the plate (18) are placed coaxially in relation to the holes (13) provided in the plate (12).

7. Device according to claim 4, characterized in that one labyrinth (20) per wad of papers (8) is provided.

8. Device according to any of claims 4 to 5, characterized in that the space (11) in which is provided at least one labyrinth (20) consists of a revolving shutter (32) whose double-walled slats each have an opening (34) at one end and are divided in two in their longitudinal directions by means of a partition (35) which is connected to the far end of the slat on the side where the openings (34) are situated, but which on the other end leave a passage from one side to the other side of the partition.

9. Device according to claims 3 and 8, characterized in that the revolving shutter (32) is mounted at a short distance from the flap (31) in the tray formed by the plate (12) and which, when closed, seals the space (7) outside of said tray.

10. Device according to any of the preceding claims, characterized in that the capsules (14) respectively consist of a metal envelope which is filled with a pyrotechnical mixture and which, at the far end situated against the plate (12) which confines the space (7) designed to hold the papers (8) to be protected is closed off by a small plate (29) made of nonflammable material and which, on the other far end, is coupled to an ignition mechanism (23).

11. Device according to claim 10, characterized in that a retarding device (22) is provided for at least a part of the capsules (14) between the ignition mechanism (23) and the pyrotechnical mixture (25 to 28).

12. Device according to any of the preceding claims, characterized in that the pyrotechnical mixture consists of an ignition charge (25) and of one or several fire destruction charges (26-27-28).

13. Device according to claim 12, characterized in that the ignition charge (25) and the fire destruction charges (26-27-28) are formed by a combination in a determined ratio of the materials and the values indicated in FIG. 10.

14. Device according to any of the preceding claims, characterized in that each capsule (14) is electrically connected to an electronic security system.

15. Device according to claim 14, characterized in that the security system contains a reversing switch (17) which is activated by a mobile part of the device.
